(19) United States
(12) Patent Application Publication
(10) Pub. No.: US 2007/0274188 A1
(43) Pub. Date: Nov. 29, 2007

(54) Multi-Layer Disk-Use Optical Pickup Device

(76) Inventor: Ikuya Kikuchi, Saitama (JP)

Correspondence Address: DRINKER BIDDLE & REATH (DC), 1500 K STREET, N.W., SUITE 1100, WASHINGTON, DC, 20005-1209, US

(21) Appl. No.: 10/590,849

(22) PCT Filed: Mar. 15, 2005
(86) PCT No.: PCT/JP05/05048

§ 371 Date: Aug. 25, 2006

(30) Foreign Application Priority Data
Apr. 15, 2004 (JP) 2004-119728

(51) Int. Cl. G11B 7/135

(52) U.S. Cl. 369/112.01

(57) ABSTRACT

An optical pickup device including: a light source for emitting a light beam; a beam expander having a converging lens for converging a light beam, a light-shielding panel having a through-portion arranged at an optical conjugate position of an emission point of the light beam for allowing the converged light beam to pass through and a collimator lens for collimating the light beam passed through the through-portion; an objective lens for focusing the collimated light beam to the recording layer; and a light detector for detecting the light beam reflected by the recording medium and passed through the objective lens and the beam expander and generating the error signal and the reading data signal for controlling the focusing position.

### TECHNICAL FIELD

The present invention relates to an optical pickup device for a multi-layer disk having a plurality of recording layers.

### BACKGROUND ART

As an information recording medium for performing optical information recording and/or optical information reproduction, optical disks such as a CD (Compact Disc) or a DVD (Digital Video Disc or Digital Versatile Disc) is known. A multi-layer optical disk in which the recording capacity per recording-layer can be increased by providing a plurality of recording layers on an identical recording surface (side) for increasing the capacity of optical disk is also known. The multi-layer optical disk of this type has a structure in which a plurality of recording layers are stacked at relatively small predetermined intervals. For example, development of a recordable multi-layer optical disk in which a recording medium such as a phase change medium is in progress.

Some of the optical pickup devices for such a multi-layer optical disk include an aberration correcting apparatus for correcting aberration generated by reflection on the optical disk. As an example of such aberration correcting apparatus in the related art, there is the one employing a beam expander for changing the beam diameter of a light beam (for example, see Japanese Laid-open Patent Application Kokai No. 10-106012). The aberration correcting apparatus using the beam expander corrects spherical aberration of a light beam generated by the difference in thickness of the optical disk by causing the lens of the beam expander to move along an optical axis of the light beam.

When recording and reproducing the optical disk having a plurality of recording layers, there is a problem of performance deterioration of the optical pickup device by light from recording layers other than an object of recording and reproduction, that is, the layer to which the light beam is focused, being mixed with a signal light. In order to avoid such mixing of unnecessary light, an optical pickup device provided with means for removing unnecessary light is disclosed (for example, see Japanese Laid-open Patent Application Kokai No. 2003-323736, No. 2001-189032, and No. 08-185640).

However, it is difficult to achieve improvement of accuracy and cost reduction and the configuration of the device is complicated in the optical pickup device in the related art as described above. The intervals of the recording layers of the multi-layer optical disk is small in association with increase in capacity of the optical disk as described above, and hence an optical pickup device in which acquisition of high quality light-receiving signals and control of high level of accuracy are enabled has been required.

### DISCLOSURE OF INVENTION

In order to solve the above-described problem, an optical pickup device in which mixing of unnecessary light can be avoided, high-quality light-receiving signals can be acquired, high-level of accuracy is achieved, and the configuration is simple is provided as an example.

An optical pickup device according to the present invention is an optical pickup device for causing an optical beam to be converged into a recording layer of a recording medium having a plurality of recording layers and receiving reflected light from the recording layer for recording and/or reproducing including: a light source for emitting a light beam; a beam expander having a converging lens for converging a light beam, a light-shielding panel having a through-portion arranged at an optical conjugate position of an emission point of the light beam for allowing the light beam converged by the light-converging lens to pass through and a collimator lens for collimating the light beam passed through the through-portion; an objective lens for focusing the light beam collimated by the beam expander to the recording layer; and a light detector for detecting the light beam reflected by the recording medium and passed through the objective lens and the beam expander and generating an error signal for controlling the focusing position and a reading data signal.

An optical pickup device according to the present invention is an optical pickup device for causing a light beam to be converged into a recording layer of a recording medium having a plurality of recording layers and receiving reflected light from the recording layer for recording and/or reading including: a beam splitter for splitting an forward optical path from a light source to a recording medium and a backward optical path from a recording medium to a light detector, and a beam expander for correcting aberration of the light beam focused onto the recording layer, the beam expander including a converging lens for converging the light beam, a light-shielding panel located at a common optical path for the forward light path and the backward light path and a through-portion located at an optical conjugate point of an emission point of the light beam, and a collimator lens for collimating the light beam which is passed through the through-portion.

### BRIEF DESCRIPTION OF THE DRAWINGS

FIG. 1 is a schematic block diagram showing a configuration of an optical pickup device according to a first embodiment of the present invention.

FIG. 2 is a schematic plan view showing a structure of a light-shielding panel shown in FIG. 1.

FIG. 3 is a schematic cross-sectional view of a structure of the light-shielding panel shown in FIG. 1.

FIG. 4 is a schematic cross-sectional view showing a structure of an optical disk having a plurality of recording layers.

FIG. 5 is a schematic drawing showing a state in which unnecessary light reflected from the optical disk is shielded by the light-shielding panel.

FIG. 6 is a drawing showing the intensity of a light-receiving signal (light amount of signal) with respect to the amount of defocusing.

FIG. 7 is a drawing showing the intensity of a focus error (FE) signal with respect to the amount of defocusing.

FIG. 8 is a plan view showing a structure of the light-shielding panel according to a second embodiment of the present invention.

FIG. 9 is a schematic drawing showing a configuration of an optical system of the optical pickup device according to a third embodiment of the present invention.

FIG. 10 is a schematic drawing showing a configuration of the optical system of the optical pickup device according to a fourth embodiment of the present invention.

FIG. 11 is a schematic drawing showing a configuration of the optical system of the optical pickup device according to a modification of the fourth embodiment.

FIG. 12 is a schematic drawing showing a configuration of the optical system of the optical pickup device according to a fifth embodiment of the present invention.

### BEST MODE FOR CARRYING OUT THE INVENTION

Referring now to the drawings, embodiments of the invention will be described in detail. In the embodiments shown below, the same components are represented by the same reference signs.

### First Embodiment

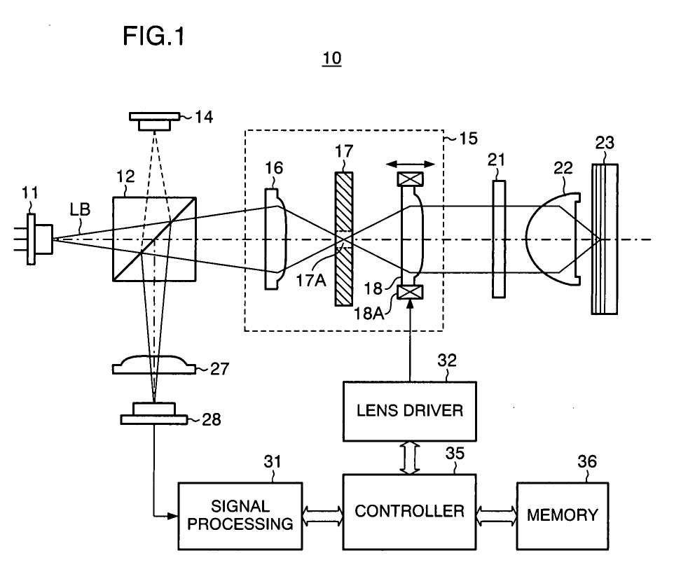

FIG. 1 is a schematic block diagram showing a configuration of an optical pickup device 10 as a first embodiment of the present invention.

A light source 11 includes, for example, a semiconductor laser for emitting a laser beam. A light beam LB from the light source 11 is partly reflected by a polarizing beam splitter 12, and is received by a power monitor 14 including a light-receiving element, so that the intensity of the light of the light source 11 is monitored. The power monitor 14 is used for monitoring the light amount from the light source 11 in the case of recording or the like, and a power monitor may be provided in the light source 11. Most part of the light beam from the light source 11 is transmitted through the polarizing beam splitter 12, and enters a beam expander 15 for correcting the spherical aberration.

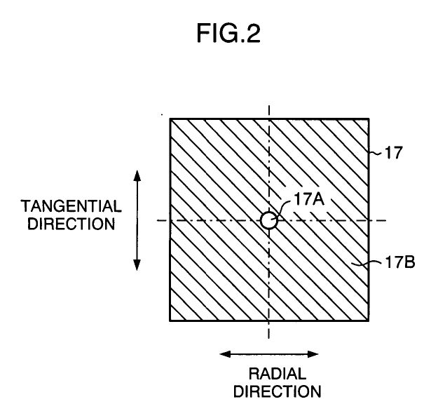

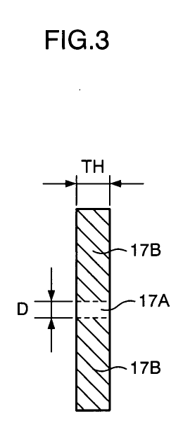

The beam expander 15 is a light converging beam expander including a converging lens 16, a light-shielding panel (unnecessary-light removing panel) 17 and a collimator lens 18. FIGS. 2 and FIG. 3 are a plan view and a cross-sectional view schematically showing a structure of the light-shielding panel 17. The light-shielding panel 17 is provided with a pinhole 17A at a center portion thereof for allowing a light beam converged by the converging lens 16 to pass through the light-shielding panel 17. The pinhole 17A has a diameter D, and the light-shielding panel 17 has a thickness TH. In other words, the pinhole 17A is formed as a column-shaped through-hole having a diameter of D and a length of TH. A part other than the through-portion (pinhole 17A) is a light-shielding area 17B that shields the laser beam. Although the pinhole 17A may be formed as a through hole, it is not limited thereto, and must simply be formed as a through-portion which can allow the converged light beam to pass through or transmit through. The shape is not limited to the column shape, and must simply have a shape that allows the converged light beam to pass through.

The collimator lens 18 is supported by a guide shaft (not shown) extending in parallel with an optical axis, and is configured to move in the direction of the optical axis (optical path) by driving an actuator 18A such as a moving coil or a step motor by a lens driver 32. Consequently, the spherical aberration of the light beam generated by the difference in thickness of the optical disk can be corrected.

The light beam from the light source 11 transmitted through the polarizing beam splitter 12 is converged by the converging lens 16, and passes through the pinhole 17A located at a light-converging point (that is, an optical conjugate point of a light beam emitting point of the light source 11). In other words, the light-shielding panel 17 is located at a position on the optical axis so that the pinhole 17A takes a conjugate position of the light emitting point of the light source 11 (a point of emission of the light beam). In other words, the through-portion (pinhole) 17A is formed into a shape including the optical conjugate point. The through-portion 17A has a pinhole diameter that allows passage of light reflected from a recording layer to which the focus of the disk is adjusted (that is, a target recording layer) and shields the reflected light from the defocused recording layer. In the same manner, the length of the through-portion 17A in the direction of the optical axis (the thickness of the light-shielding panel 17) is set so as to allow light reflected from the focused recording layer to pass through and light reflected from the defocused recording layer to be shielded. In other words, the shape and the size of the through-portion 17A can be determined according to the shape and the size of the beam at the through-portion 17A of the light reflected from the focused recording layer.

The light beam passed through the pinhole 17A of the light-shielding panel 17 is converted into a substantially parallel beam by the collimator lens 18. The beam expander 15 is arranged between the polarizing beam splitter 12 and an objective lens 22. The through-portion 17A preferably has a size that can shield the light reflected from the defocused recording layer almost completely.

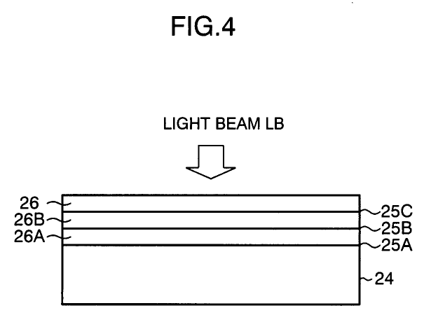

The substantially parallel light beam from the beam expander 15 is converted into a circularly polarized light by a λ/4 (quarter-wave) plate 21 and enters the objective lens 22. The light beam converged by the objective lens 22 enters the optical disk 23 and is reflected therefrom. The objective lens 22 is driven to focus the light beam to be focused to a desired layer of the optical disk 23. More specifically, as shown in FIG. 4, the optical disk 23 is formed with a plurality of recording layers (recording surfaces) on a substrate 24. An example in which the optical disk 23 has three recording layers will be described below. A first recording layer 25A, a second recording layer 25B, and a third recording layer 25C are formed on the substrate 24. Spacer layers (intermediate layers) 26A, 26B are formed between the first recording layer 25A and the second recording layer 25B, and between the second recording layer 25B and the third recording layer 25C, respectively, and a cover layer (protective layer) 26 is formed on the third recording layer 25C (disk surface).

In the following description, a case of recording the information data signal, or reproducing the recorded data signal on/from the first recording layer 25A will be described. The optical beam entered into the optical disk 23 passes through the third recording layer 25C and the second recording layer 25B and focused on the first recording layer 25A. This light is reflected from the first recording layer 25A and is returned to the objective lens. The light beam entered into the optical disk 23 is partly reflected by the third recording layer 25C and the second recording layer 25B. The reflected light is unnecessary light which deteriorates the quality of the signal.

The signal light from the first recording layer 25A, being reflected from a focused plane (recording layer), passes through the objective lens 22 and enters the polarizing beam splitter 12 through an optical path identical to the forward path. The light reflected from the optical disk 23 is converted into a polarized state which is orthogonal to the polarized state of the forward path by the λ/4 (quarter-wave) plate 21. Therefore, the reflected light is reflected by the beam splitter 12, converged by a converging element 27 including a servo control signal optical element, and enters a light detector 28. In other words, the forward light path and the backward optical path (or return path) are split by the polarizing beam splitter 12. A half mirror or the like can be used instead of the polarizing beam splitter. The light detector 28 is provided with the light-receiving element for receiving the reflecting light from the focused recording layer and generating the reading data signal, and a light receiving element- for generating a servo control signal for generating an error signal for controlling the focusing position including a focus error, a tracking error and so on.

On the other hand, the reflected light (unnecessary light) from the second recording layer 25B and the third recording layer 25C, being the light reflected from the defocused plane, passes an optical path different from the forward path as divergent light and enters the collimator lens 18 of the beam expander 15 to be converged. However, since the divergent light is converged, it is not converged at the position of the pinhole 17A, and most part of the reflected light (unnecessary light) is shielded by the light-shielding panel 17.

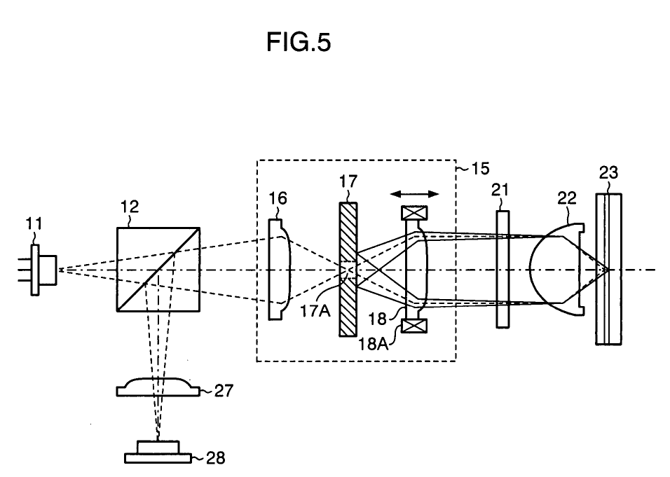

FIG. 5 schematically shows that the reflected unnecessary light from the optical disk 23 is shielded by the light-shielding panel 17. An optical path to the recording layer focused by the objective lens 22 (target recording layer, the first recording layer 25A in this case) is indicated by a broken line, and an optical path of the reflected unnecessary light from the defocused recording layer (second recording layer 25B and/or third recording layer 25C) is indicated by a solid line. As shown in the drawing, the reflected light from the defocused recording layer is not converged at the position of the pinhole 17A, and hence cannot pass through the light-shielding panel 17. Although the aberration of the light beam can be corrected by moving the collimator lens 18 in the direction of the optical axis, as long as the pinhole 17A is located at an optical conjugate position of the light source 11 (the point of emission of the light beam), the focusing position of the reflected light from the target recording layer does not change even though the collimator lens 18 is moved for correcting the aberration.

In order to obtain the optical pickup device 10 having the capability, it is necessary to provide the pinhole 17A accurately. However, as described below, the positioning of the pinhole 17A can be performed with a simple manner. In other words, when the pinhole 17A is arranged at an optical conjugate position (or the converging point of the converging lens 16) of the emission point of the light beam, eclipse of the light beam by the pinhole 17A does not occur in the forward path of the light beam. The diameter of the pinhole 17A is set to a diameter larger than the light convergence spot diameter. Therefore, for example, a light power meter is arranged immediately after the collimator lens 18, and the light power from the converging lens 16 is monitored in a state in which the light-shielding panel 17 is not arranged first. Subsequently, the light-shielding panel 17 is inserted, and the position of the light-shielding panel 17 on planes in the direction of the optical axis of the light beam and in the direction vertical to the optical axis (that is, the position of the pinhole 17A) is adjusted. The pinhole 17A can be positioned accurately by adjusting the position of the light-shielding panel 17 so that the light power detected by the light power meter becomes the same magnitude as the light power before insertion of the light-shielding panel 17.

As described above, the reflected unnecessary light is shielded, thus unnecessary light passing through the pinhole 17A is only a small part (less than 1%) of the entire unnecessary light. Although a part of the unnecessary light passed through the pinhole 17A is converged by the converging element 27, since it is defocused with respect to the light detector 28, the amount of the unnecessary light mixed to the signal light in the light detector 28 is further reduced to a negligible extent. Therefore, the information data signal and the servo signal detected by the light detector 28 are not affected by other recording layers, and hence the high-quality detected signal can be acquired.

The reading data signal and the servo signal from the light detector 28 are processed by a signal processing circuit 31, and are delivered to a controller 35. The controller 35 drives the beam expander 15 to control the spherical aberration correction. The controller 35 generates various controls signals according to an operating state of the optical pickup device 10, and controls the entire optical pickup device 10 such as signal processing required for reproducing and recording the data signal. A storage device (or memory) 36 for storing data or the like required for the above-described control is connected to the controller 35.

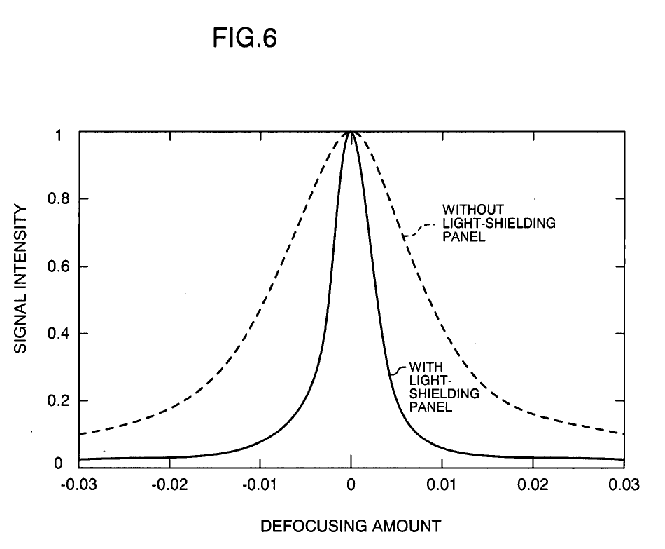

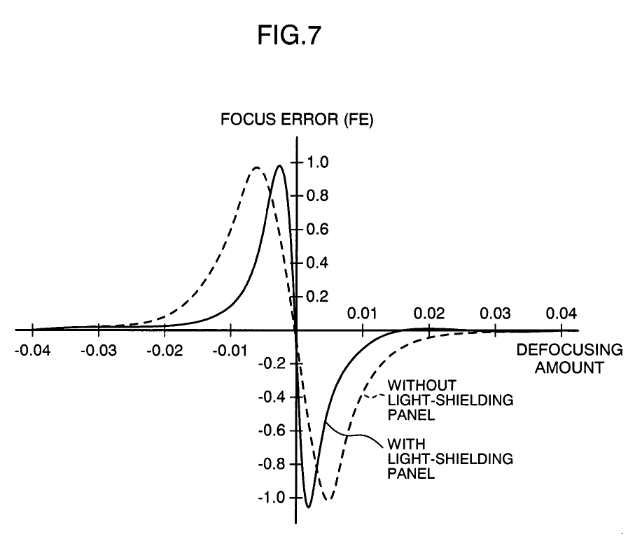

FIG. 6 shows the intensity of the light-receiving signal (the light amount of the signal) with respect to the amount of defocusing. In other words, the intensity of the signal in the case in which the light-shielding panel 17 having the pinhole 17A is provided (shown by a solid line) is compared with a case in which the light-shielding panel 17 is not provided (shown by a broken line). FIG. 7 shows the intensity of a focus error signal (FE) with respect to the amount of defocusing. In other words, the intensity of the error signal is compared between the cases in which the light-shielding panel 17 is provided (shown by the solid line) and is not provided (shown by the broken line). In FIG. 6 and FIG. 7, the intensity of the light-receiving signal and the intensity of the focus error signal are normalized to approximately 1 in the cases in which the light-shielding panel 17 is provided and not provided for facilitating comparison.

As shown in FIG. 6 and FIG. 7, in the case in which the light-shielding panel 17 is not provided, both of the signal light and the focus error remain even when being defocused by, for example, ±0.02 (about 5 μm), and deterioration of the signal-noise ratio (SNR) and offset of the focus error are resulted even with the inter-layer thickness in this extent. On the other hand, in the case in which the light-shielding panel 17 is provided, mixing of the unnecessary light in the signal light is on the order of 1/100, though is not zero, in the defocusing of about ±0.02 (about 5 μm), so that a sufficiently high SNR is achieved. The intensity of the focus error signal is almost zero, and there is no offset occurred. Therefore, a high-quality light-receiving signal (data signal) is obtained, and the reliability of the error signal is high, and hence focusing position control (focusing control, tracking control) can be performed with a high degree of accuracy. The configuration can be simplified, and hence a compact optical pickup device is realized.

According to the invention, the pinhole 17A is provided on the common optical path for the forward and backward (return) paths between the element (beam splitter 12) for separating the forward path and the backward path of the light beam and the objective lens 22. Since a capture range is limited by the pinhole 17A in this configuration, focus servo or the like can be performed with a high degree of accuracy without increasing the magnification of the servo error detecting optical system.

### Second Embodiment

The optical pickup device 10 according to a second embodiment of the invention will be described. The optical pickup device 10 is configured to perform the tracking control by a three-beam method. In other words, the optical system of the optical pickup device 10 includes an optical element that generates a main beam and two sub-beams from a laser beam of the light source 11. For example, the main beam and the sub-beams are generated by a grating element arranged between the light source 11 and the polarizing beam splitter 12. Other configurations are the same as the first embodiment.

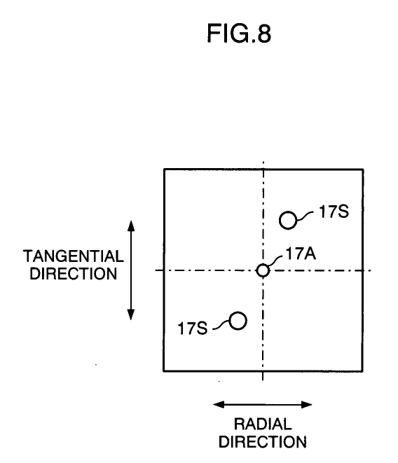

FIG. 8 is a plan view showing a structure of the light-shielding panel 17 of the embodiment. The light-shielding panel 17 is provided with a main beam pinhole 17A at a center portion thereof for allowing the converged main beam light to pass through the light-shielding panel 17, and sub-beam pinholes 17S are provided symmetrically about the main beam pinhole 17A so that the two sub-beams used for the tracking control or the like can pass therethrough.

The diameters of the respective sub-beam pinholes 17S are larger than the main beam pinhole 17A so that the positions of the sub-beams can be rotationally adjusted about the optical axis. Alternatively, the diameters of the respective sub-beam pinhole 17S may be an oval along an arcuate about the optical axis, or an arcuate part having a predetermined width, or the like.

In this configuration, the invention can be applied also to the case in which the control with the three-beam method is performed.

### Third Embodiment

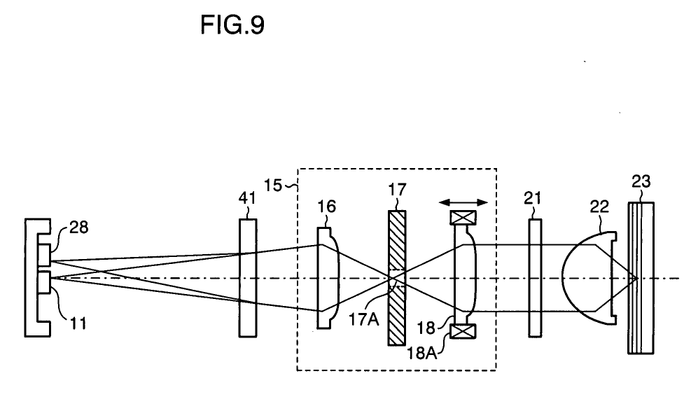

FIG. 9 is a schematic drawing showing a configuration of the optical system of the optical pickup device 10 according to a third embodiment of the invention. The signal processing circuit 31 and circuits of the lens driver 32, the controller 35, the storage device 36, and so on of the optical pickup device 10 are omitted in the drawing.

An aspect of the embodiment different from the above-described embodiment is that a polarizing hologram element is used instead of the beam splitter 12. The optical system is provided with the light-converging beam expander 15 including the converging lens 16, the light-shielding panel 17, and the collimator lens 18, the λ/4 (quarter-wave) plate 21, the objective lens 22, and the light detector 28.

In this embodiment, the optical system of the optical pickup device 10 is configured to split the forward path and the backward path (return path) of the light beam using a polarizing hologram element 41. The light-shielding panel 17 having the pinhole 17A provided at the optical conjugate position of the point of emission of the light beam is arranged on the common optical path for the forward and backward optical beams. Therefore, as in the embodiments shown above, the reflected light (unnecessary light) from the defocused recording layer is not converged at the position of the pinhole 17A and is shielded by the light-shielding panel 17.

Therefore, deterioration of the signal-noise ratio (SNR) and occurrence of offset in the error signal can be avoided. In other words, the high-quality light-receiving signal (data signal) can be acquired, and the control of the focusing position (focusing control, tracking control) can be performed with a high degree of accuracy. A compact optical pickup device with a simple configuration is realized.

In this configuration, since the hologram element is employed, the configuration of the pickup is simple. In other words, the aberration correcting apparatus with a high SNR and a high level of accuracy and low cost can be achieved with a simple and compact configuration.

### Fourth Embodiment

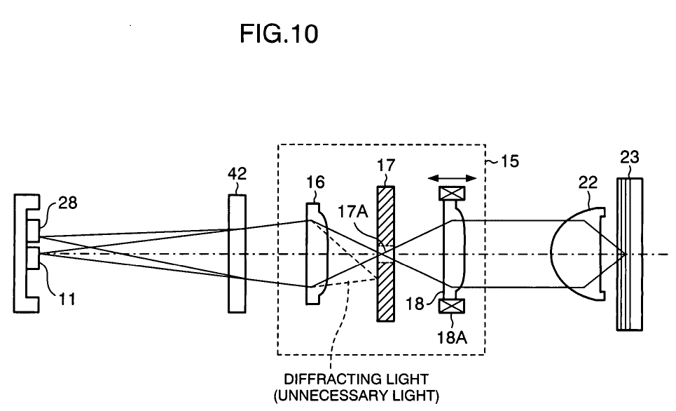

FIG. 10 is a schematic drawing showing the configuration of the optical system of the optical pickup device 10 according to a fourth embodiment. A point different from the above-described embodiments is that a hologram element 42 is employed instead of the beam splitter 12. In the same manner as the above-described embodiments, the light-converging beam expander 15 including the converging lens 16, the light-shielding panel 17, and the collimator lens 18, the objective lens 22, and the light detector 28. The hologram element 42 is a normal hologram which is not a polarizing type, and in this example, the λ/4 wave plate is not used.

In other words, it is configured so that the forward and backward paths of the light beam are split using the hologram element 42. The light-shielding panel 17 having the pinhole 17A at the optical conjugate position at the emission point of the light beam is arranged on the optical path common for the forward and backward optical beams. Therefore, in the same manner at the above-described embodiments, the reflected light (unnecessary light) from the defocused recording layer is not converged at the position of the pinhole 17A and is shielded by the light-shielding panel 17. In this embodiment, the diffracted light (unnecessary light) such as a primary diffracted light can be shielded also in the forward path of the laser beam emitted from the light source 11, whereby the adverse effect by the unnecessary light can be avoided.

Therefore, the deterioration of the signal-noise ratio (SNR) and the occurrence of the offset of the focus error can be avoided. In this configuration, since the hologram element is employed, the configuration of the pickup is simple. In other words, the aberration correcting apparatus having a high SNR at low cost with a high degree of accuracy can be achieved in a simple structure.

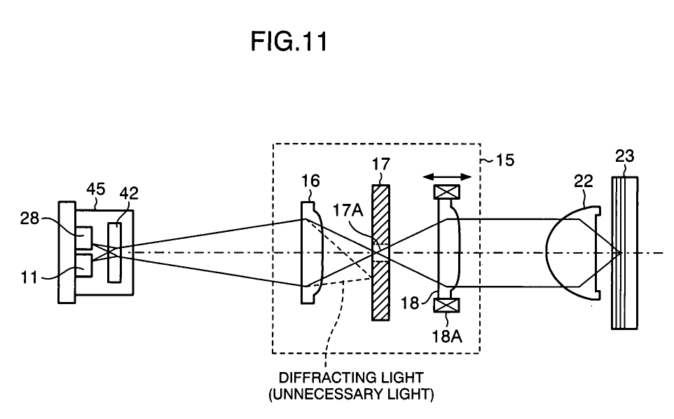

As shown in a modification shown in FIG. 11, a hologram integrated unit (HOE) 45 having the light source 11, the hologram element 42, and the light detector 28 can be employed. In addition, the aberration correcting apparatus at low cost and a high SNR with a high degree of accuracy can be provided.

### Fifth Embodiment

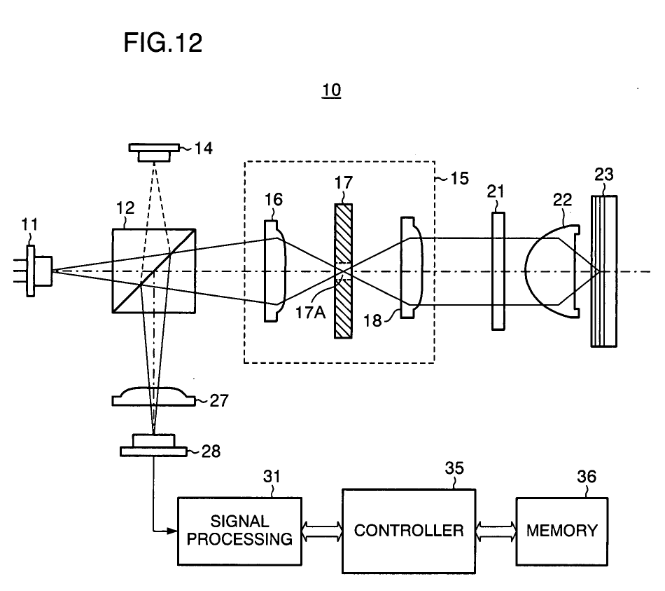

FIG. 12 is a schematic block diagram showing a configuration of the optical pickup device 10 according to a fifth embodiment of the invention.

In the above-described embodiment, the case in which the drive unit having the actuator 18A and the driver (lens driver 32) which drives the actuator 18A so that the aberration can be corrected by driving the beam expander 15 at the time of recording or reproducing the optical disk is provided has been described. A case in which the drive unit is not provided will be described.

In the embodiment, the beam expander 15 is adjusted in advance, and the arrangement of the converging lens 16, the light-shielding panel 17 and the collimator lens 18 is fixed. For example, at the time of assembly of the optical pickup device 10, the spherical aberration correction is adjusted for a predetermined recording layer of the optical disk, and is fixed in this state. For example, in the case of the three-layer optical disk having three recording layers, an initial adjustment is performed so that the aberration correction with respect to the second recording layer as an intermediate recording layer thereof becomes optimal. For example, in the case of the four-layer optical disk having four recording layers, the initial adjustment is performed so that the aberration correction with respect to the second recording layer or the third recording layer as the intermediate recording layers becomes optimal. In other words, in the optical disk having a plurality of recording layers, the initial adjustment may be performed so that the aberration correction with respect to a recording layer which is the closest to the center position of the layer structure including the plurality of recording layers (and the spacer layers) becomes optimal. In this manner, the above-described problems such as the SNR or the offset can be avoided practically by adjusting the amount of aberration correction so as to match the recording layer positioned at the center of the optical disk out of the plurality of recording layers.

1. An optical pickup device for causing an optical beam to be converged into a recording layer of a recording medium having a plurality of recording layers and receiving reflected light from the recording layer for recording and/or reading comprising:
a light source for emitting a light beam;
a beam expander having a converging lens for converging a light beam, a light-shielding panel having a through-portion located at an optical conjugate point of an emission point of the light beam on a common optical path for the forward light path and the backward light path, and a collimator lens for collimating the light beam passed through the through-portion;
an objective lens for focusing the light beam collimated by the beam expander to the recording layer; and
a light detector for detecting the light beam reflected by the recording medium and passed through the objective lens and the beam expander to generate an error signal for controlling the focusing position and a reading data signal,
wherein the light source includes an optical element for generating a main beam and a sub beam, and the light-shielding panel includes through-portions arranged at optical conjugate positions of the main beam and the sub beam, the through-portions corresponding to the main beam and the sub beam, respectively.

2. The optical pickup device according to claim 1, wherein the beam expander includes a driver for driving the collimator lens in the direction of an optical axis of the light beam for correcting an aberration of the light beam focused to the recording layer.

3. The optical pickup device according to claim 1, wherein the through-portion has a size that can shield reflected light from a recording layer other than the recording layer to which the light beam is focused.

4. (canceled)

5. The optical pickup device according to claim 1, wherein the through-portion corresponding to the sub-beam has a diameter larger than the through-portion corresponding to the main beam.

6. The optical pickup device according to claim 1, comprising a hologram element arranged on an optical path between the light source and the converging lens for introducing the reflected light beam passed through the beam expander to the light detector.

7. An optical pickup device for causing a light beam to be converged into a recording layer of a recording medium having a plurality of recording layers and receiving reflected light from the recording layer for recording and/or reading comprising:
a beam splitter for splitting an forward optical path from a light source to a recording medium and a backward optical path from a recording medium to a light detector; and
a beam expander for correcting aberration of the light beam focused onto the recording layer,
the beam expander including a converging lens for converging the light beam, a light-shielding panel having a through-portion located at an optical conjugate point of an emission point of the light beam on a common optical path for the forward light path and the backward light path, and a collimator lens for collimating the light beam which is passed through the through-portion,
wherein the light source includes an optical element for generating a main beam and a sub beam, and the light-shielding panel includes through-portions arranged at optical conjugate positions of the main beam and the sub beam, the through-portions corresponding to the main beam and the sub beam, respectively.

8. The optical pickup device according to claim 7, wherein the light-shielding panel allows the reflected light from the recording layer to which the light beam is focused to pass through and shields the reflected light from the defocused recording layer.
